(19) United States
(12) Patent Application Publication
(10) Pub. No.: US 2005/0248963 A1
(43) Pub. Date: Nov. 10, 2005

(54) Circuit for controlling the reverse recovery current in a blocking diode

(76) Inventor: Chung Yan Cheng, Shatin (CN)

Correspondence Address: HARNESS, DICKEY & PIERCE, P.L.C., P.O. BOX 828, BLOOMFIELD HILLS, MI, 48303, US

(21) Appl. No.: 10/842,018

(22) Filed: May 7, 2004

(51) Int. Cl. H02M 3/335

(52) U.S. Cl. 363/17

(57) ABSTRACT

The reverse recovery current control circuit for a power converter. The reverse recovery control circuit includes a diode and a winding which prevents freewheeling current during the off period of the switching circuit on a primary side of the converter to flows through the output rectifiers. The diode and a set of secondary windings are placed across the output rails of the power converter. One end of the secondary windings connects to the end of the primary inductor that also connects to the output rectifiers.

### FIELD OF THE INVENTION

The present invention relates to power converters which output a direct current (DC) voltage and, more particularly, to a circuit for controlling the reverse recovery current of a blocking diode in a power converter.

### BACKGROUND OF THE INVENTION

In the broadest sense, power converters are directed to processing of electrical power using electronic devices to perform a function on a power input and yield a controlled power output. One such converter may be referred to as a switching converter. A switching converter receives a power input, performs a function on that power input, and yields a power output. Switching converters may be further defined by the type of power input and power output. For example, a DC-DC converter converts a DC input voltage to a DC output voltage having a desired magnitude and polarity. An AC-DC converter, commonly referred to as a rectifier, receives an AC input voltage and produces a DC output voltage. Conversely, a DC-AC converter, typically referred to as an inverter, transforms a DC input voltage into an AC output voltage of controllable magnitude and frequency.

With particular respect to converters which generate a DC power output, a number of such converters exist, including buck, boost, buck-boost, Cuk, voltage-source inverters, and the like. Other functions include step-down of voltage, step-up of voltage, polarity inversion, and conversion of DC to AC power or vice-versa. Converters may be used in conjunction with transformer isolation in order to isolate power at the input ports from power at the output ports and vice-versa. A transformer typically provides DC isolation between the input and output ports of a converter system. For example, in an off-line application, the converter input is connected to an AC input typically received from an electrical utility network. The transformer isolates DC power between the primary and secondary sides of the transformer.

One particular type of isolated converters comprise full-bridge or half-bridge isolated buck converters. A buck converter may be used to provide 42 volt or 48 volt output power, by way of example, and typically include diode or output rectifiers at the secondary side of the transformer. Operation of the switches of the full-bridge or half-bridge on the primary side of the transformer generates an AC signal which will be rectified by the converter at the secondary side of the transformer. During operation of a conventional full-bridge converter, switch pairs are operated on the primary side of the transformer in order to provide the desired AC signal input to the transformer. During selected portions of the switching cycle, all four switches are off. During the interval in which all switches are off, current freewheels through the rectifiers on the secondary side of the circuit.

In a conventional full bridge converter, the freewheeling current causes a relatively high reverse recovery current through one of the rectifiers when one of the switch pairs turns on and through the other rectifier when the other switch pair turns on. This reverse recovery current causes voltage spikes at the blocking diode. The reverse recovery current also causes the temperature of the rectifier to increase, which correspondingly increases the reverse recovery current and corresponding voltage spike at that diode. Eventually, the voltage spikes rise to a level that exceed the rating of the typical output rectifier utilized on the secondary side of the transformer. By way of example, the output rectifiers on a secondary side of a converter that outputs voltages in the 48 volt range require ratings in the 200-300 volt range. Such high voltage ratings renders the use of Schottky diodes impractical, and ultrafast rectifier diodes are used instead.

Some attempts to limit the freewheeling current and corresponding voltage spikes have utilized a diode between the voltage rails at the output of the converter. The diode is placed in a location which is advantageous, as the voltage stress on the diode is substantially less than the voltage stress upon the output rectifiers, so that the diode may be used as a freewheeling diode. This in turn increases efficiency and may decrease or limit the reverse recovery current through the output rectifiers if all the output current flows through the freewheeling diode when the switches of the bridge are all off. However, conventional output inductors or chokes do not insure that all output current flows through the freewheeling diode placed between the voltage rails. In a typical case, most of the freewheeling current flows through the output rectifiers rather than through the freewheeling diode. This leads to a higher reverse recovery current through the output rectifiers.

Thus, it is desirable to provide a circuit for controlling the reverse recovery current to the output rectifiers.

### SUMMARY OF THE INVENTION

This invention is directed to a power converter circuit including an input switching circuit. The input switching circuit receiving a first voltage and generates an AC voltage. An isolation circuit has a primary side and a secondary side, and the primary side is attached to receive the AC voltage from the input switching circuit. A rectifier circuit connects to the secondary side of the isolation circuit, and the rectifier circuit including at least a pair of rectifiers. A reverse recovery current control circuit on the secondary side of the isolation circuit includes a secondary inductor having a first end connected to a primary inductor and a diode connected to a second end of the secondary inductor. The secondary inductor inhibits current flow through the pair of rectifiers when no voltage is applied to the primary side of the isolation circuit.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 depicts a block diagram of the converter circuit arranged in accordance with the principles of the present invention;

FIG. 2 depicts a circuit diagram of the reverse recovery current control circuit of the present invention; and

FIGS. 3a-3d depict waveforms for describing operation of the present invention.

### DETAILED DESCRIPTION OF THE PREFERRED EMBODIMENTS

The following description of the preferred embodiment(s) is merely exemplary in nature and is in no way intended to limit the invention, its application, or uses.

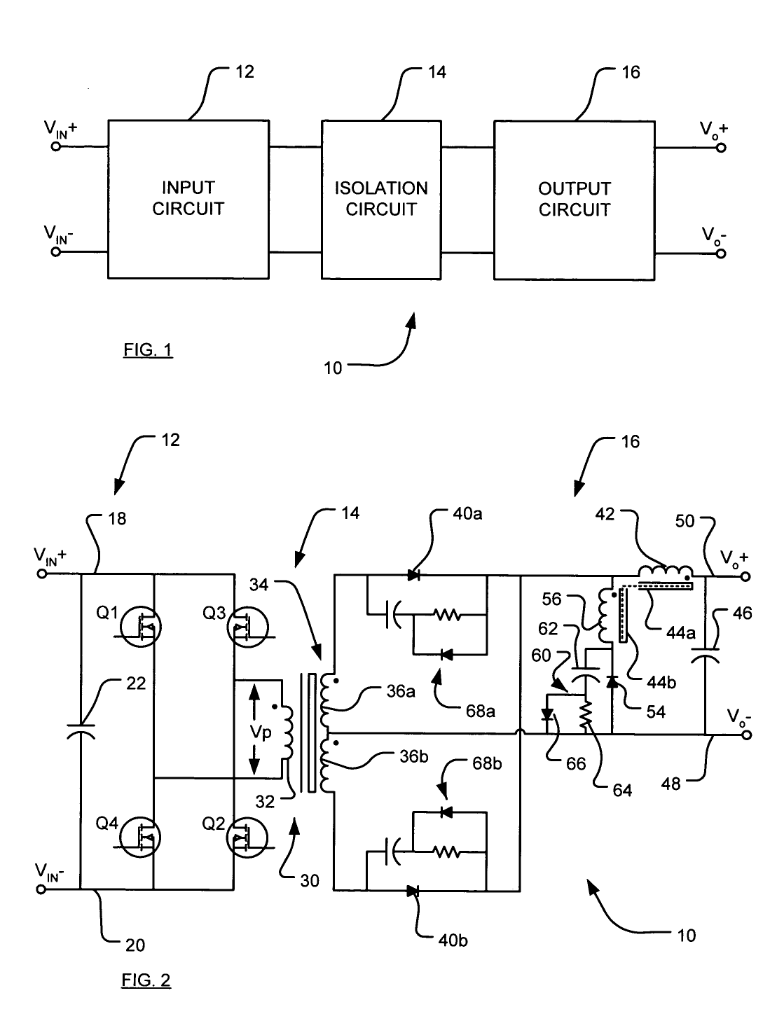

The present invention will be described with respect to FIGS. 1 and 2. FIG. 1 depicts a block diagram of a bridge-type isolated buck power converter 10. The input voltage Vin is applied to an input circuit 12 which performs a predefined function on input voltage Vin. Input circuit 12 generates an output applied to isolation circuit 14 which in turn generates an input applied to output circuit 16. Output circuit 16 receives the input and generates a voltage output Vo. With respect to this invention, input circuit 12 will be described with respect to a bridge-type switching circuit and, more particularly, a full-bridge switching circuit, but is equally applicable to any bridge-type circuit, including half-bridge and push-pull configurations. Isolation circuit 14 will be described with respect to an isolation transformer. Output circuit 16 will be described with respect to a buck converter. Although the present invention will be described as discussed with respect to FIG. 1, one skilled in the art will recognize that the subject invention may be equally applied to various power converter topologies including AC-DC and DC-DC converters. One skilled in the art will further recognize the applicability of the invention described herein when output circuit 16 is configured in connection with any of a number of known converted topologies including a center-tapped or bridge-rectifier buck converter.

With respect to FIG. 2, FIG. 2 depicts a circuit diagram corresponding to the block diagram of FIG. 1. A voltage input Vin is applied across the respective positive rail 18 and negative rail 20 of input circuit 12. A capacitor 22 across voltage rails 18, 20 provides electrical protection for the switches of bridge-type switching circuit 12. Bridge-type switching circuit 12 defined herein is a full-bridge switching network including switches Q1, Q2, Q3, Q4. Switches Q1 and Q4 are connected in series across voltage rails 18, 20, and switches Q2 and Q3 are connected in series across voltage rails 18, 20. The switches shown in FIG. 2 are depicted as MOSFET switches, but one skilled in the art will recognize that other switch configurations may be used to provide the bridge-type switching circuit 12. As is well known in the art, switches Q1 and Q2 operate as a pair and switches Q3, Q4 operate as a pair as well in order to convert the incoming DC signal Vin into an AC signal applied to the primary side of isolation circuit 14.

Isolation circuit 14 is embodied herein as an isolation transformer 30. Isolation transformer 30 includes a primary side 32 connected to bridge-type switching circuit 12 and a secondary side 34 connected to output circuit 16. Transformer 30 includes a primary winding 32 and a secondary winding 36 comprising a pair of center-tapped secondary windings 36a, 36b. The center-tap of secondary 36 defines a reference for the output voltage Vo.

As described above, output circuit 16 is embodied as a buck converter. The buck converter includes a pair of output rectifiers 40a, 40b connected to the ends opposite the tap of respective secondary windings 36a, 36b. The anode of each output rectifier 40a, 40b connects to the respective ends of secondary windings 36a, 36b. The cathode of each output rectifier 40a, 40b connects to an end of a primary inductor 42, also referred to as an output choke. The other end of output choke 42 connects to the positive rail 50 of output Vo. Output choke 42 includes a core 44a. An output capacitor 46 connects across the negative voltage rail 48 and the positive voltage rail 50 of the output Vo.

A diode 54 has an anode connected to negative voltage rail 48 and a cathode connected to the first end of a supplemental winding 56. The second end of the supplemental winding 56 connects to an end of primary inductor 42 as shown. Supplemental winding 56 includes a core 44b, and windings 42, 56 share a common core, which will generally be referred to as core 44.

A protection circuit 60 comprising a capacitor 62, resistor 64, and diode 66 is placed in parallel with diode 54. Capacitor 62 and resistor 64 are placed in series across diode 54, and diode 66 is placed in parallel across resistor 64 to act as a voltage clamp across resistor 64. Protection circuit 60 operates to dissipate voltage spikes caused by leakage inductance from additional winding 56 as well as other components. Protection circuits 68a and 68b are configured similarly to protection circuit 60 and are placed in parallel across respective output rectifiers 40a, 40b. In a preferred configuration, additional winding 56 comprises fewer turns than primary inductor 42. By way of example, for a converter receiving an input voltage of 390 volts and generating an output voltage of 42 volts, supplemental winding 56 may include between 3 to 4 turns, while primary output choke 42 comprises 10 turns. It will be understood by one skilled in the art that diodes 66, 68a, 68b are optionally implemented in accordance with power levels at which power converter 10 operates and the printed circuit board (PCB) layout. For lower power levels and good PCB layouts, these diodes may be eliminated.

In operation, when switches Q1-Q4 of bridge-type switching circuit 12 are turned off, supplemental winding 56 applies a reverse bias to output rectifiers 40a, 40b to prevent output rectifiers 40a, 40b from conducting. During this interval, induced voltage at supplemental winding 56 directs at least a substantial portion of the freewheeling current through diode 54. This insures that minimal or, in some cases, no current flows through output rectifiers 40a, 40b prior to one of the respective switching pairs Q1, Q2 or Q3, Q4 turning on. Thus no reverse recovery current flows through output rectifiers 40a, 40b when one of the respective switching pairs Q1, Q2 or Q3,Q4 turn on. More specifically, if diode 54 is implemented as a Schottky diode, no reverse recovery current flows through diode 54 even though all freewheeling current flows through it prior to one of the respective switching pairs Q1, Q2 or Q3, Q4 turns on.

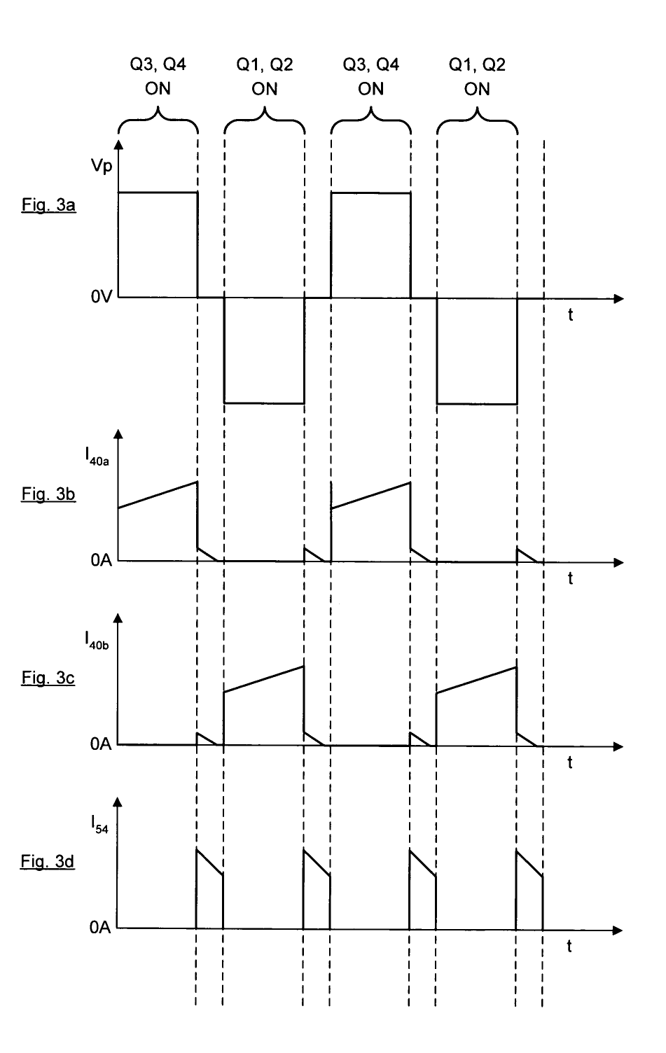

Operation of power converter 10 can be better understood with reference to FIGS. 3a-3d. FIG. 3a. depicts a waveform of the voltage Vp at the primary 32 of transformer 30. Voltage Vp is positive when switching pair Q3, Q4 are on and negative when switching pair Q1, Q2 is on. FIG. 3a also shows periods when all four switches Q1-Q4 are off. During .this period Vp equals 0 volts. FIG. 3b depicts a waveform of the current I₄₀ₐ flowing through output rectifier 40a, and FIG. 3c depicts a waveform of the current I_{40b} flowing through output rectifier 40b Current flows through output rectifier 40a when switching pair Q3, Q4 is on, and current flows through output rectifier 40b when switching pair Q1, Q2 is on. Conversely, no current flows through output rectifier 40a when switching pair Q1, Q2 is on, and no current flows through output rectifier 40b when switching pair Q3, Q4 is on.

During the periods when all four switches Q1-Q4 are off, minimal freewheeling current flows through output rectifiers 40a, 40b. This minimal freewheeling current dissipates to zero in each output rectifier 40a, 40b. As can also be seen in each of FIGS. 3b, 3c, prior to when one of the switching pairs Q1, Q2 or Q3, Q4 turns on, current flowing through both output rectifiers 40a, 40b has dissipated to zero. Thus when one of the switching pairs Q1, Q2 or Q3, Q4 turn on, no current is flowing in either output rectifier 40a, 40b. Because no current flows through either output rectifier 40a, 40b when one of switching pairs Q1, Q2 or Q3, Q4 turns on, no reverse recovery current flows thorough either output rectifier 40a, 40b.

FIG. 3d depicts a waveform of the current 154 flowing through diode 54. As can be seen in FIG. 3d, when diode 54 is implemented as a Schottky diode, no reverse recovery current flows through diode 54 when either of switching pairs Q1, Q2 or Q3, Q4 turn on. The waveform of FIG. 3d also demonstrates that almost all of the freewheeling current flowing through the output circuit 16 when all switches Q1-Q4 are off flows through diode 54 and that almost no freewheeling current flows through output rectifiers 40a, 40b.

As can be seen from the foregoing, the coupled choke configuration described herein limits or, in some cases, eliminates, the reverse recovery current through output rectifiers 40a, 40b, This substantially limits the voltage spike at output rectifiers 40a, 40b caused by reverse recovery current. Further, the present configuration decreases high frequency noise generated by the power supply and limits voltage breakdown of output rectifiers 40a, 40b. Further yet, the working duty cycle of the switches of bridge-type switching circuit 12 decreases in comparison to a conventional bridge-type converter thereby extending holdup time as a converter.

The description of the invention is merely exemplary in nature and, thus, variations that do not depart from the gist of the invention are intended to be within the scope of the invention. Such variations are not to be regarded as a departure from the spirit and scope of the invention.

1. A power converter circuit comprising:
a primary inductor at an output of the converter circuit; and
a reverse recovery suppression circuit comprising:
a secondary inductor having a first end connected to the primary inductor; and
a diode connected to a second end of the secondary inductor, wherein the secondary inductor causes freewheeling current to flow through the diode.

2. The power converter circuit of claim 1 further comprising at least a pair of output rectifiers, the pair of output rectifiers connected to the primary inductor and to the first end of the secondary inductor, wherein operation of the power converter circuit defines a conducting period and a non-conducting period for each output rectifier of the pair, and the reverse recovery suppression circuit prevents reverse recovery current from flowing through each output rectifier when a respective output rectifier changes from a non-conducting to a conducting period.

3. The power converter circuit of claim 2 wherein the diode is a Schottky diode.

4. The power converter circuit of claim 1 further comprising a switching circuit receiving an input power and generating an AC output signal.

5. The power converter circuit of claim 4 further comprising an isolation circuit interposed between the switching circuit and the primary inductor.

6. The power converter circuit of claim 5 further comprising at least a pair of output rectifiers interposed between the isolation circuit and the primary inductor, the pair of output rectifiers connected to the primary inductor and to the first end of the secondary inductor, wherein operation of the power converter circuit defines a conducting period and a non-conducting period for each output rectifier of the pair, and the reverse recovery suppression circuit prevents reverse recovery current from flowing through each output rectifier when a respective output rectifier changes from a non-conducting to a conducting period.

7. The power converter circuit of claim 6 wherein the non-conducting period is defined as when no voltage appear is applied across the isolation circuit.

8. The power converter circuit of claim 4 wherein the switching circuit is one of the group of a half-bridge circuit, a full-bridge circuit, or a push-pull circuit.

9. The power converter circuit of claim 1 further comprising a voltage suppression circuit in parallel with the diode.

10. The power converter circuit of claim 1 further comprising a resistive-capacitive circuit in parallel with the diode.

11. The power converter circuit of claim 10 further comprising a clamping diode in parallel with the resistor of the resistive-capacitive circuit.

12. A power converter circuit comprising:
a input switching circuit, the input switching circuit receiving a first voltage and generating an AC voltage;
an isolation circuit having a primary side and a secondary side, the primary side being attached to receive the AC voltage from the input switching circuit;
a rectifier circuit connected to the secondary side of the isolation circuit, the rectifier circuit including at least a pair of rectifiers; and
a reverse recovery current control circuit on the secondary side of the isolation circuit, the reverse recovery current control circuit including:
a secondary inductor having a first end connected to a primary inductor; and
a diode connected to a second end of the secondary inductor, wherein the secondary inductor inhibits current flow through the pair of rectifiers when no voltage is applied to the primary side of the isolation circuit.

13. The power converter circuit of claim 12 wherein the rectifier circuit connects at a first terminal to the primary inductor and at a second terminal to the isolation circuit, wherein operation of the reverse recovery current control circuit inhibits the flow of the reverse recovery current through the rectifier circuit.

14. The power converter circuit of claim 12 further comprising:
a first output rectifier, the first output rectifier connecting at a first terminal to the primary inductor and at a second terminal to a first terminal of the isolation circuit; and
a second output rectifier, the second output rectifier connecting at a first terminal to the primary inductor and at a second terminal to a second terminal of the isolation circuit.

15. The power converter circuit of claim 12 wherein the input switching circuit is one of the group of a half-bridge circuit, a full-bridge circuit, or a push-pull circuit.

16. A power converter circuit comprising:
a pair of output rectifiers receiving a rectified AC signal, pair of output rectifiers;
a primary inductor at the output of the pair of output rectifiers;
a reverse recovery current control circuit connected to the pair of output rectifiers and the primary inductor, the reverse recovery current control circuit including:
a secondary inductor having a first end connected to the primary inductor; and
a diode connected to a second end of the secondary inductor,
wherein operation of the power converter circuit defines a conducting period and a non-conducting period for each output rectifier of the pair and the reverse recovery suppression circuit prevents reverse recovery current from flowing through each output rectifier when a respective output rectifier changes from a non-conducting to a conducting period.

17. The power converter circuit of claim 16 wherein the non-conducting period is defined as when no voltage appear is applied across the isolation circuit.

18. The power converter circuit of claim 16 further comprising a switching circuit receiving an input power and generating an AC output signal to the output rectifiers.

19. The power converter circuit of claim 18 wherein the switching circuit is one of the group of a half-bridge circuit, a full-bridge circuit, or a push-pull circuit.
